(19) United States
(12) Patent Application Publication
(10) Pub. No.: US 2026/0292719 A1
(43) Pub. Date: Sep. 24, 2026

(54) SYNCHRONIZATION RASTER

(71) Applicant: Samsung Electronics Co., Ltd., Suwon-si (KR)

(72) Inventors: Javad Abdoli, Plano, TX (US); Young Han Nam, Plano, TX (US); Hongbo Si, Allen, TX (US)

(21) Appl. No.: 19/538,806

(22) Filed: Feb. 12, 2026

Related U.S. Application Data
(60) Provisional application No. 63/775,768, filed on Mar. 21, 2025.

(51) Int. Cl. H04W 56/00

(52) U.S. Cl. CPC H04W 56/00

(57) ABSTRACT

A method of operating a user equipment (UE) in a wireless communication system includes determining a set of synchronization raster entries, determining a first set of frequencies based on the set of synchronization raster entries, and detecting a first type of synchronization signal based on a first frequency in the first set of frequencies. The method also includes obtaining a first set of system information based on the detected first type of synchronization signal, determining a second frequency based on the first frequency, and receiving a second type of synchronization signal at the second frequency.

### CROSS-REFERENCE TO RELATED APPLICATION(S) AND CLAIM OF PRIORITY

This application claims priority under 35 U.S.C. § 119 (e) to U.S. Provisional Patent Application No. 63/775,768 filed on Mar. 21, 2025. The above-identified provisional patent application is hereby incorporated by reference in its entirety.

### TECHNICAL FIELD

This disclosure relates generally to wireless networks. More specifically, this disclosure relates to synchronization rasters.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides title apparatuses and methods for synchronization rasters.

In one embodiment, a method of operating a user equipment (UE) in a wireless communication system is provided. The method includes determining a set of synchronization raster entries, determining a first set of frequencies based on the set of synchronization raster entries, and detecting a first type of synchronization signal based on a first frequency in the first set of frequencies. The method also includes obtaining a first set of system information based on the detected first type of synchronization signal, determining a second frequency based on the first frequency, and receiving a second type of synchronization signal at the second frequency.

In another embodiments, a method of operating a base station (BS) in a wireless communication system is provided. The method includes determining a set of synchronization raster entries, determining a first set of frequencies based on the set of synchronization raster entries, and determining a first frequency in the first set of frequencies for a first type of synchronization signal. The method also includes determining a first set of system information included in the first type of synchronization signal, and determining a second frequency, based on the first frequency, for a second type of synchronization signal. The method further includes transmitting the first type of synchronization signal at the first frequency, and transmitting the second type of synchronization signal at the second frequency.

In yet another embodiment, an electronic device is provided. The electronic device includes at least one processor including processing circuitry, and memory storing instructions. The instructions, when executed by the at least one processor individually or collectively, cause the electronic device to determine a set of synchronization raster entries, determine a first set of frequencies based on the set of synchronization raster entries, and detect a first type of synchronization signal based on a first frequency in the first set of frequencies. The instructions, when executed by the at least one processor individually or collectively, also cause the electronic device to obtain a first set of system information based on the detected first type of synchronization signal, determine a second frequency based on the first frequency, and receive a second type of synchronization signal at the second frequency.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example antenna beamforming architecture according to embodiments of the present disclosure;

FIG. 5 illustrates an example synchronization raster design, where each of a synchronization raster Type-1 and synchronization raster Type-2 are a subset of a mother frequency grid according to embodiments of the present disclosure;

FIG. 6 illustrates an example synchronization raster design, where a synchronization raster Type-1 is a subset of a synchronization raster Type-2 according to embodiments of the present disclosure;

FIGS. 7A-7D illustrate example reference points for frequency offsets according to embodiments of the present disclosure;

FIG. 8 illustrates an example UE procedure for SSB detection according to embodiments of the present disclosure;

FIG. 9 illustrates an example synchronization raster design, where a value of fₛₜₐᵣₜ is determined by a frequency offset with respect to a raster point in synchronization raster Type-1 on which a UE detects an SSB Type-1 according to embodiments of the present disclosure;

FIGS. 10-14 illustrate example synchronization raster designs, where a value of fₛₜₐᵣₜ is determined by a predefined rule according to embodiments of the present disclosure;

FIG. 15 illustrates another example UE procedure for SSB detection according to embodiments of the present disclosure;

FIGS. 16-18 illustrate example synchronization raster designs, where a frequency location of SSB Type-2 is determined from an SSB Type-1 which is detected by a UE on synchronization raster Type-1 according to embodiments of the present disclosure;

FIG. 19 illustrates another example UE procedure for SSB detection according to embodiments of the present disclosure;

FIG. 20 illustrates a synchronization raster design, where FDMed SSBs are adjacent in frequency and the bandwidth of each SSB is equal to Δf₂. according to embodiments of the present disclosure;

FIG. 21 illustrates a synchronization raster design, where FDMed SSBs are adjacent in frequency and the bandwidth of each SSB is equal to 2×Δf₂ according to embodiments of the present disclosure;

FIG. 22 illustrates a synchronization raster design, where FDMed SSBs are not adjacent in frequency according to embodiments of the present disclosure;

FIG. 23 illustrates an example method for SSB detection according to embodiments of the present disclosure; and

FIG. 24 illustrates an example method for SSB detection according to embodiments of the present disclosure.

### DETAILED DESCRIPTION

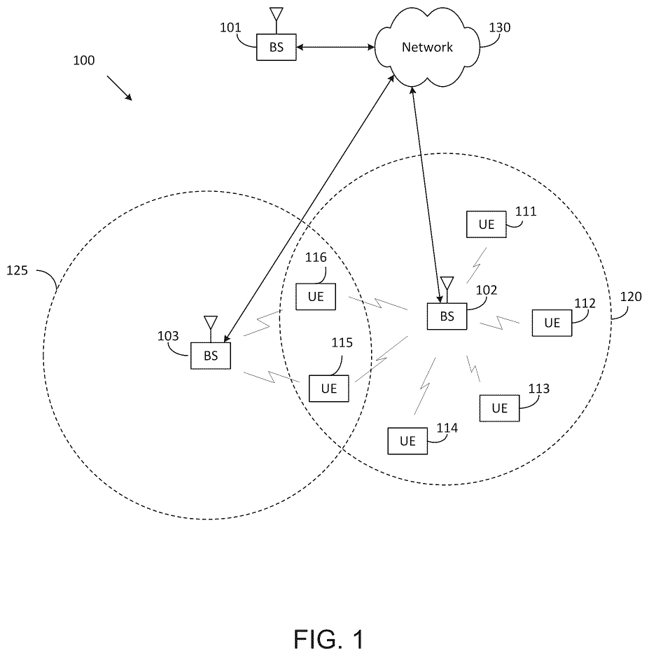

FIGS. 1 through 24, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for synchronization rasters. In certain embodiments, one or more of the gNBs 101-103 includes circuitry, programing, or a combination thereof, to support synchronization rasters in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

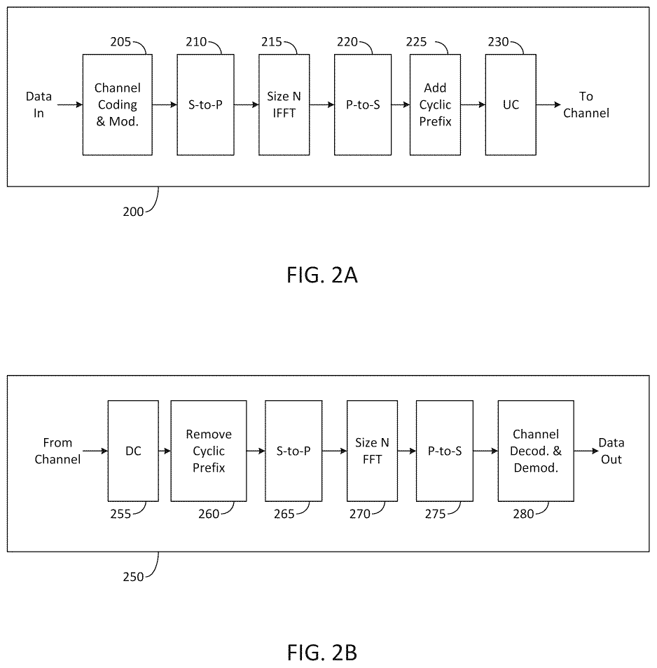

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support synchronization rasters as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

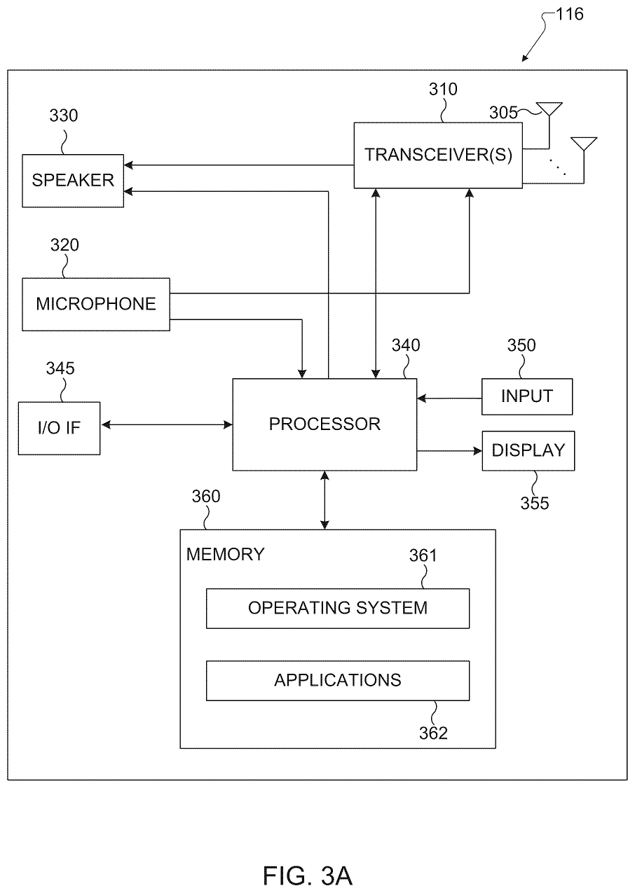

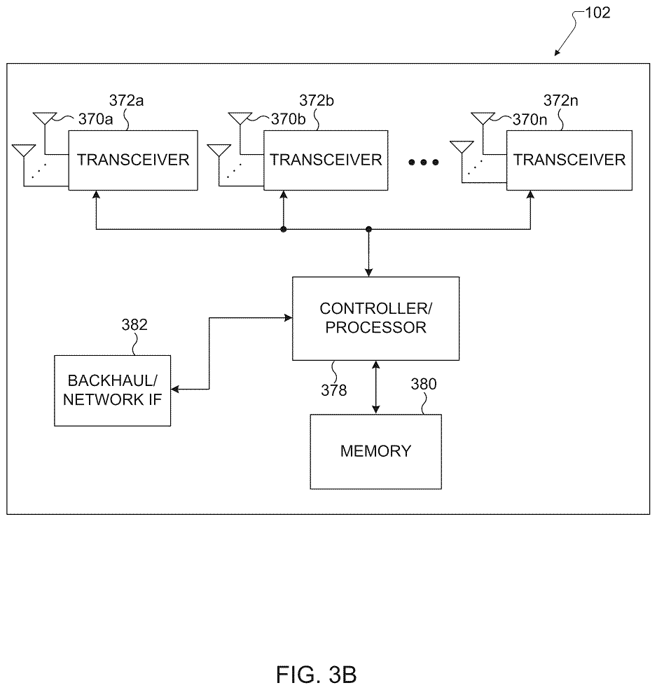

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for synchronization rasters as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support synchronization rasters as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

Rel.13 LTE supports up to 16 channel state information (CSI)-reference signal (RS) antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel.14 LTE. For next generation cellular systems such as 5G, it is expected that the maximum number of CSI-RS ports will remain more or less the same.

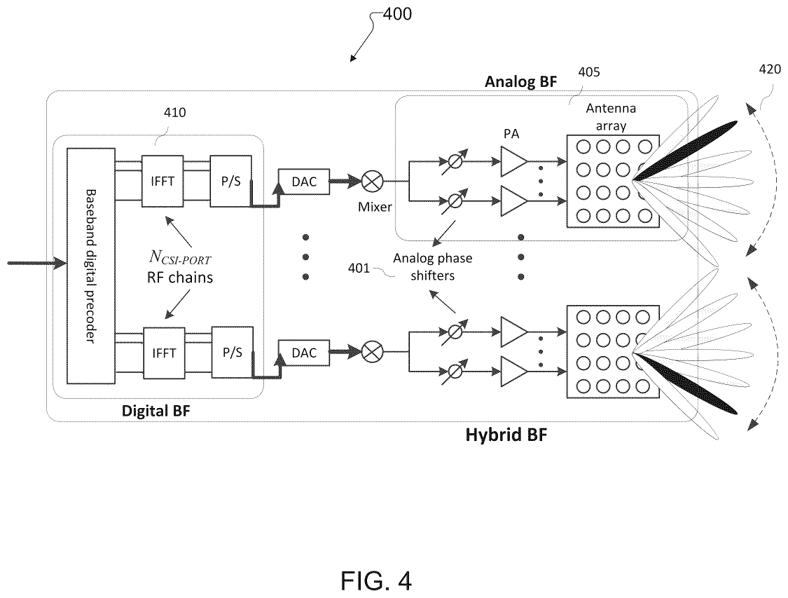

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mm Wave frequencies) as illustrated by beamforming architecture 400 in FIG. 4.

FIG. 4 illustrates an example antenna beamforming architecture 400 according to embodiments of the present disclosure. The embodiment of the antenna beamforming architecture illustrated in FIG. 4 is for illustration only. Different embodiments of an antenna beamforming architecture could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks (RBs).

Although FIG. 4 illustrates one example antenna beamforming architecture 400, various changes may be made to FIG. 4. For example, various components in FIG. 4 could be combined, further subdivided, or omitted and additional components could be added according to particular needs.

Transmission of downlink (DL) synchronization signal blocks (SSBs) is an important component in some wireless communication systems. In systems such as these, each SSB may be comprised of a primary synchronization signal (PSS), a secondary synchronization signal (SSS), and a physical downlink broadcast channel (PBCH). In these systems, detection/decoding of an SSB may be the first step for any UE to initially access the wireless network. A UE, after detecting/decoding an SSB, can obtain DL reception timing which can be used for reception of any other DL transmissions in the system. Furthermore, after decoding a PBCH, the UE can obtain other information used to initially access the network.

In networks where an SSB is the very first DL signal detected/decoded by any UE before the UE can access the network, a UE does not have prior information on the exact time and/or frequency location of an SSB transmitted by the network. Therefore, in networks such as these, a UE may try to blindly detect PSS/SSS on multiple frequency locations within the frequency band and multiple time instances until the UE successfully detects a valid PSS/SSS. In order to limit the number of blind detections in frequency, and so, reduce SSB detection complexity of UEs, certain frequency grids (sets of frequency values) called “synchronization raster” or Global Synchronization Channel Number (GSCN) may be defined. In 5G NR, the synchronization raster indicates the frequency locations of the SSB that can be used by a UE for accessing the system when explicit signaling of the SSB position is not present. Also, in 5G NR, an SSB is transmitted periodically in time with a certain periodicity. This allows for any UE, if it decides to access the network, to have an opportunity to detect an SSB within a time duration not exceeding the SSB transmission periodicity. This implies that an SSB is an “always-on” signal in 5G NR.

A wireless system with a single SSB type, such as 5G NR, may not be efficient in terms of UE and/or network energy consumption. Wireless systems with multiple SSB types can provide a better tradeoff between UE/network energy consumption and frequency/time synchronization accuracy. The existing synchronization raster in 5G NR supports transmission of one SSB at a given time. For a wireless communication system design with multiple SSB types, a proper synchronization raster design is desirable. Various embodiments of the present disclosure provide synchronization raster designs for multiple SSB types. Various embodiments of the present disclosure also provide synchronization raster designs for multiple frequency division multiplexed (FMDed) SSBs (e.g., using joint phase-time array (JPTA) beamforming), which may provide additional gains to the system. Hereinafter, an SSB in the multiple SSB types can refer to a synchronization signal block, which may include a PSS, and/or a SSS, and/or a PBCH in the various embodiments of the present disclosure. In one example, the multiple SSB types can be associated with different parameters and/or structures of the SSB, such as a periodicity of the SSB transmission, and/or a time location (e.g., a time offset within the periodicity, and/or half frame index) of the SSB transmission, and/or a power of the SSB transmission, and/or a bandwidth of the SSB transmission, and/or a frequency location of the SSB transmission, and/or a spatial information (e.g., SSB indexes) on the SSB transmission, and/or components included in the SSB, and/or multiplexing pattern of components included in the SSB.

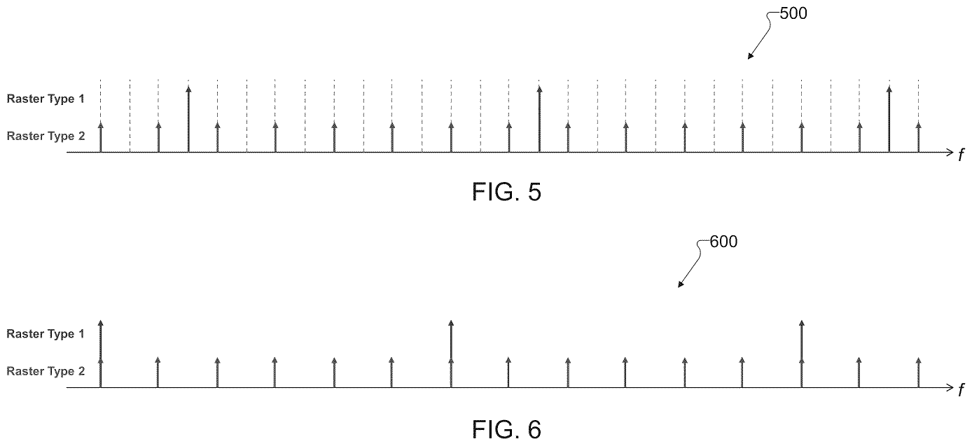

In some embodiments, such as shown in FIGS. 5-8, a number “M” of SSB types (i.e., SSB Type-1, SSB Type-2, . . . , SSB Type-M) can be specified in the specifications of a technical standard. In embodiments such as these, a number “M” of synchronization rasters (i.e., synchronization raster Type-1, synchronization raster Type-2, . . . , synchronization raster Type-M) can also be specified in the specifications of the same technical standard, wherein synchronization raster Type-j, where 1≤j≤M, corresponds to SSB Type-j.

In some embodiments, frequency points within each of the M synchronization rasters can constitute a subset of a same frequency grid, called a mother frequency grid, similar as shown in FIG. 5.

FIG. 5 illustrates an example synchronization raster design 500, where each of a synchronization raster Type-1 and synchronization raster Type-2 are a subset of a mother frequency grid according to embodiments of the present disclosure. The embodiment of a synchronization raster design of FIG. 5 is for illustration only. Different embodiments of a synchronization raster design could be used without departing from the scope of this disclosure.

In the example of FIG. 500, where M=2, each of the M synchronization rasters (synchronization raster Type-1 and synchronization raster Type-2) is a set of equispaced frequency points (i.e., frequency points which are spaced apart at equal frequency distances, named the frequency granularity of the synchronization raster). For example, a frequency granularity of each of the M synchronization rasters can be an integer multiple of a frequency granularity of the mother frequency grid.

Although FIG. 5 illustrates one example synchronization raster design 500, various changes may be made to FIG. 5. For example, various changes to the number of synchronization rasters could be made, various changes to the frequency granularity of the synchronization rasters could be made, etc. according to particular needs.

In some embodiments, different synchronization raster types can be subsets of each other in a nested manner, similar as shown in FIG. 6. In an example of a nested relationship between synchronization rasters, synchronization raster Type-1⊆ synchronization raster Type-2 ⊆ . . . ⊆ synchronization raster Type-M.

FIG. 6 illustrates an example synchronization raster design 600, where a synchronization raster Type-1 is a subset of a synchronization raster Type-2 according to embodiments of the present disclosure. The embodiment of a synchronization raster design of FIG. 6 is for illustration only. Different embodiments of a synchronization raster design could be used without departing from the scope of this disclosure.

In the example of FIG. 600, where M=2, synchronization raster Type-1 is a subset of synchronization raster Type-2 (i.e., synchronization raster Type-1 E synchronization raster Type-2).

Although FIG. 6 illustrates one example synchronization raster design 600, various changes may be made to FIG. 6. For example, various changes to the number of synchronization rasters could be made, various changes to the frequency granularity of the synchronization rasters could be made, etc. according to particular needs.

In some embodiments, each synchronization raster Type-j, where 2≤j≤M, can be a set of one or more localized raster points (also referred to as raster clusters). In embodiments such as these, each raster cluster (i) can include K raster points (also referred to as raster cluster size), (ii) can be located with a frequency offset with respect to a raster point in synchronization raster Type-1, and (iii) the raster cluster size and the frequency offset can be specified in the specifications of a technical standard.

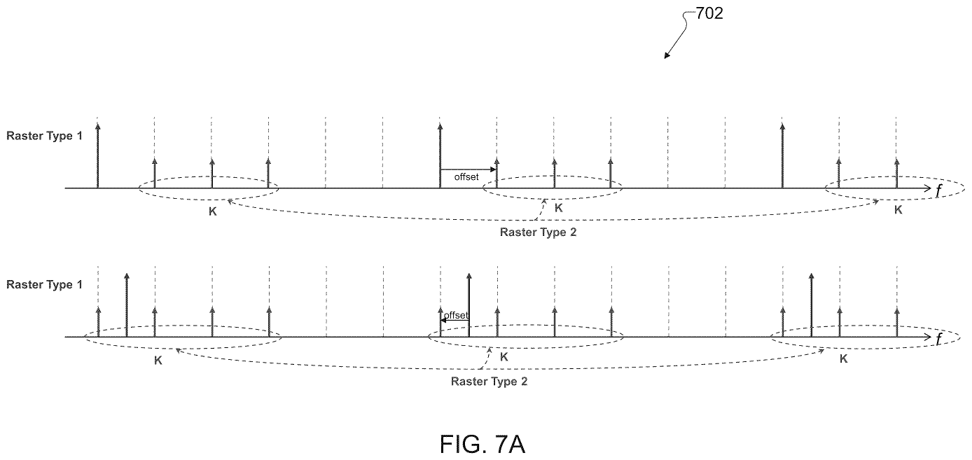

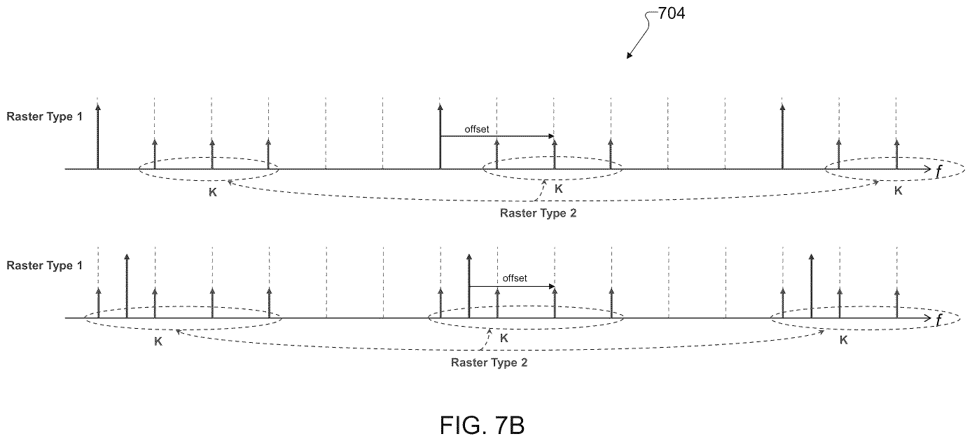

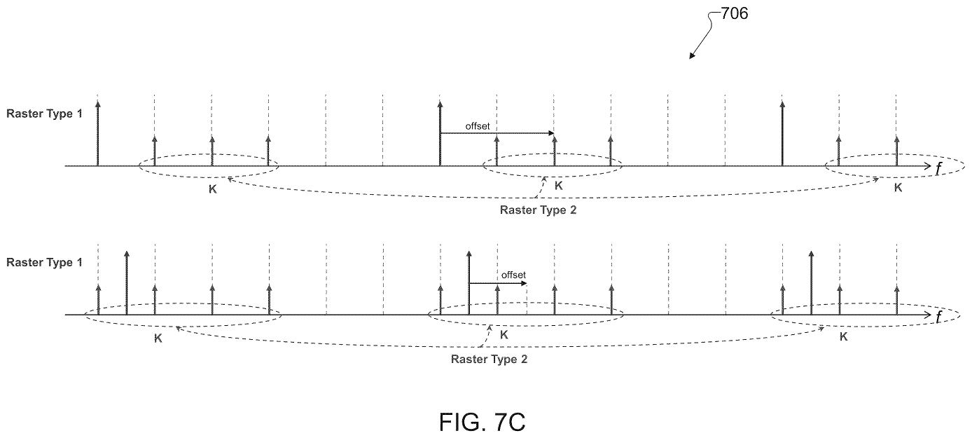

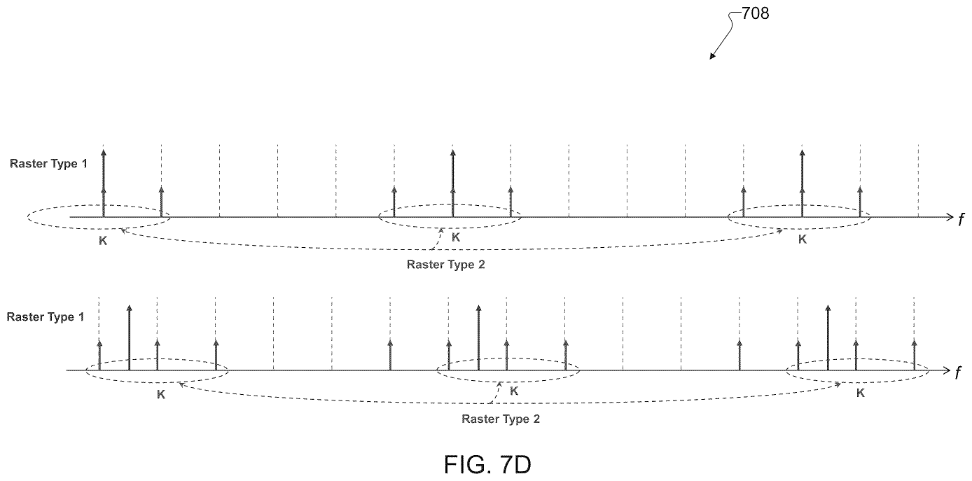

In some embodiments, the frequency offset can be from a raster point in a first synchronization raster to a starting or ending raster point of a corresponding raster cluster in a second synchronization raster, similar as shown in FIG. 7A.

In some embodiments, the frequency offset can be from a raster point in a first synchronization raster to a middle raster point of a corresponding raster cluster in a second synchronization raster, similar as shown in FIG. 7B.

In some embodiments, the frequency offset can be from a raster point in a first synchronization raster to a center frequency position of a corresponding raster cluster in a second synchronization raster, similar shown in FIG. 7C. In one example of these embodiments, the same frequency offset can be specific to a frequency band for which the rasters are specified. In another example of these embodiments, the frequency offset can be specific to a frequency range for which the rasters are specified. In a special case, for any of these embodiments, the frequency offset can be zero, similar as shown in FIG. 7D.

FIGS. 7A-7D illustrate example reference points for frequency offsets 702, 704, 706, and 708 according to embodiments of the present disclosure. The embodiments of reference points for frequency offsets of FIGS. 7A-7D are for illustration only. Different embodiments of reference points for frequency offsets could be used without departing from the scope of this disclosure.

In the example of FIGS. 7A-7D, M=2, and each raster cluster in a synchronization raster Type-2 is located with an offset to a raster point in a synchronization raster Type-1.

In FIG. 7A the frequency offset is from a raster point in a synchronization raster Type-1 to a starting raster point of a corresponding raster cluster in a synchronization raster Type-2.

In FIG. 7B, the frequency offset is from a raster point in a synchronization raster Type-1 to a middle raster point of a corresponding raster cluster in a synchronization raster Type-2.

In FIG. 7C, the frequency offset is from a raster point in a synchronization raster Type-1 to a center frequency position of a corresponding raster cluster in a synchronization raster Type-2.

In FIG. 7D, the frequency offset is equal to zero and a synchronization raster Type-2 is a set of raster clusters each centered at a raster point in a synchronization raster Type-1.

Although FIGS. 7A-7D illustrates example reference points for frequency offsets 702, 704, D706, and 708, various changes may be made to FIGS. 7A-7D. For example, various changes to the number of synchronization rasters could be made, various changes to the frequency granularity of the synchronization rasters could be made, etc. according to particular needs.

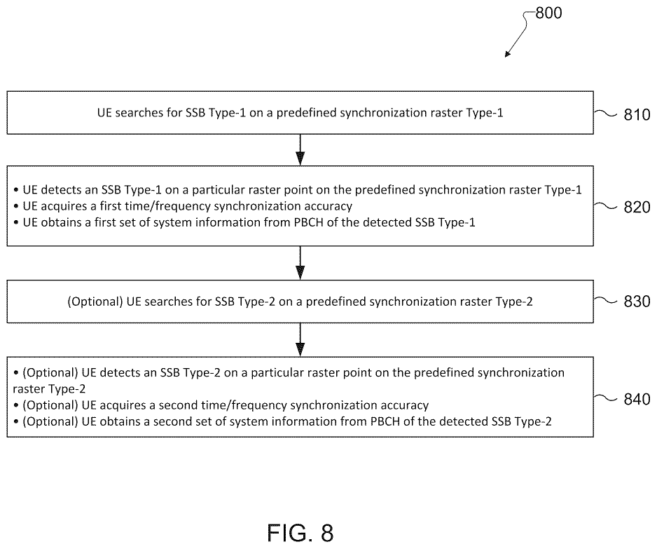

FIG. 8 illustrates an example UE procedure for SSB detection 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for SSB detection could be used without departing from the scope of this disclosure.

In the example of FIG. 8, the procedure 800 begins at operation 810. At operation 810, a UE (such as UE 116 of FIG. 1) searches for SSB Type-1 on a predefined synchronization raster Type-1. For example, the predefined synchronization raster Type-1 could be similar as described regarding any of FIGS. 5-7D.

In some embodiments, at operation 820, the UE detects an SSB Type-1 on a particular raster point on the predefined synchronization raster Type-1, acquires a first time/frequency synchronization accuracy, and obtains a first set of system information from PBCH of the detected SSB Type-1. Alternatively, in some embodiments, at operation 820, the first set of system information can be obtained from a system information block (e.g., SIB1) associated with the detected SSB Type-1.

Optionally, at operation 830, the UE searches for SSB Type-2 on a predefined synchronization raster Type-2. For example, the predefined synchronization raster Type-2 could be similar as described regarding any of FIGS. 5-7D.

Optionally, in some embodiments, at operation 840, the UE detects an SSB Type-2 on a particular raster point on the predefined synchronization raster Type-2, acquires a second time/frequency synchronization accuracy, and obtains a second set of system information from PBCH of the detected SSB Type-2. Alternatively, in some embodiments, at operation 840, the second set of system information can be obtained from a system information block (e.g., SIB1) associated with the detected SSB Type-2.

Although FIG. 8 illustrates one example UE procedure for SSB detection 800, various changes may be made to FIG. 8. For example, while shown as a series of operations, various operations in FIG. 8 could overlap, occur in parallel, occur in a different order, occur any number of times, be omitted, or replaced by other operations.

In some embodiments, such as shown in FIGS. 7A-7D and 9-15, a number “M” of SSB types (i.e., SSB Type-1, SSB Type-2, . . . , SSB Type-M) can be specified in the specifications of a technical standard. In embodiments such as these, a first synchronization raster (i.e., synchronization raster Type-1, for SSB Type-1) can also be specified in the specifications of the same technical standard. For an SSB Type-j, where 2≤j≤M, a corresponding synchronization raster (i.e., synchronization raster Type-j) can be determined by a UE using an SSB Type-1 after detecting the SSB Type-1 on the synchronization raster Type-1.

In some embodiments, each synchronization raster Type-j, where 2≤j≤M, is a set of one or more localized raster points (also referred to as raster clusters). In embodiments such as these, each raster cluster (i) can include K raster points (also referred to as raster cluster size), (ii) can be located with a frequency offset with respect to a raster point in synchronization raster Type-1, and (III) the frequency offset can be determined by an SSB Type-1 which is transmitted on synchronization raster Type-1.

In some embodiments, the frequency offset can be from a raster point in a first synchronization raster to a starting or ending raster point of a corresponding raster cluster in a second synchronization raster, similar as shown in FIG. 7A.

In some embodiments, the frequency offset can be from a raster point in a first synchronization raster to a middle raster point of a corresponding raster cluster in a second synchronization raster, similar as shown in FIG. 7B.

In some embodiments, the frequency offset can be from a raster point in a first synchronization raster to a center frequency position of a corresponding raster cluster in a second synchronization raster, similar shown in FIG. 7C.

In some embodiments, the frequency offset can be signaled in a payload of a PBCH of an SSB Type-1, or indicated by/derived from a DMRS of a PBCH of an SSB Type-1, or partially signaled in a payload of a PBCH of an SSB Type-1 and partially indicated by/derived from a DMRS of a PBCH of the SSB Type-1. Alternatively, in some embodiments, the frequency offset can be signaled in a system information block (e.g., SIB1).

In some embodiments, a value of K can be predefined and specified in the specifications of a technical standard. For one example, K=1.

In some embodiments, a value of K can be signaled in a payload of a PBCH of an SSB Type-1 which is detected by the UE, or indicated by/derived from a DMRS of a PBCH of an SSB Type-1 which is detected by the UE, or partially signaled in a payload of a PBCH of an SSB Type-1 which is detected by the UE and partially indicated by/derived from a DMRS of a PBCH of the SSB Type-1 which is detected by the UE. Alternatively, in some embodiments, the value of K can be signaled in a system information block (e.g., SIB1).

In some embodiments, each synchronization raster Type-j, where 2≤j≤M, can be a set of localized raster points which are determined by their number (K), frequency granularity (Δf), and the starting frequency point (fₛₜₐᵣₜ). One or more of these parameters can be determined by an SSB Type-1 which is detected by a UE.

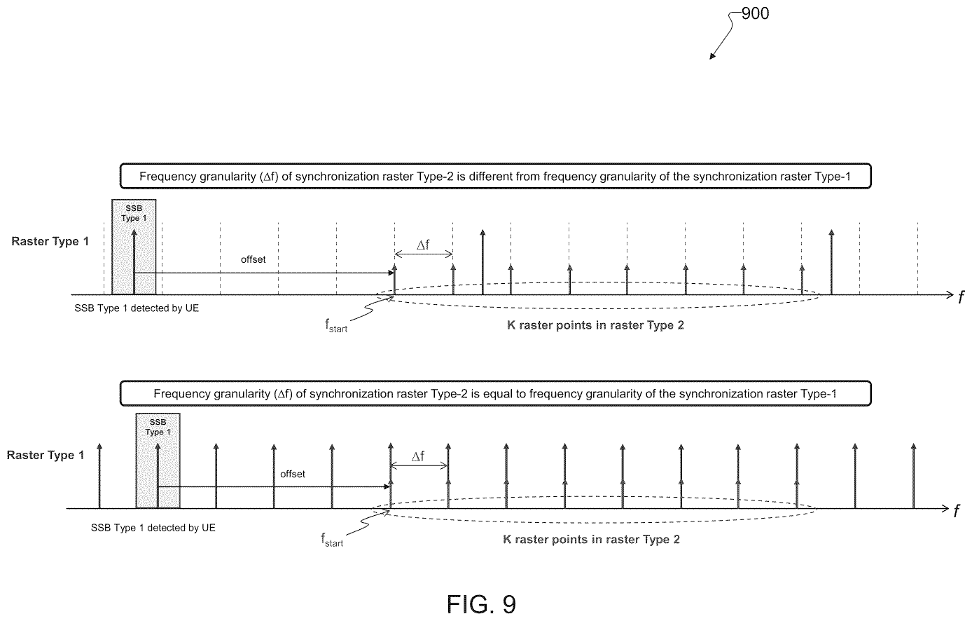

In some embodiments, a value of fₛₜₐᵣₜ can be determined by a frequency offset with respect to a raster point in synchronization raster Type-1 on which a UE detects an SSB Type-1, similar as shown in FIG. 9.

FIG. 9 illustrates an example synchronization raster design 900, where a value of fₛₜₐᵣₜ is determined by a frequency offset with respect to a raster point in synchronization raster Type-1 on which a UE detects an SSB Type-1 according to embodiments of the present disclosure. The embodiment of a synchronization raster design of FIG. 9 is for illustration only. Different embodiments of a synchronization raster design could be used without departing from the scope of this disclosure.

In the example of FIG. 9, a value of the frequency offset can be determined by any of the following options:

In some embodiments, a value of the frequency offset can predefined and can be specified in the specification of a standards specifications In an example of this option, the frequency offset can be an integer multiple of a predefined frequency granularity, wherein the integer multiple is predefined per frequency band per subcarrier spacing.

In some embodiments, a value of the frequency offset can be signaled in a payload of a PBCH of the SSB Type-1 which is detected by the UE, or indicated by/derived from a DMRS of a PBCH of the SSB Type-1 which is detected by the UE, or partially signaled in a payload of a PBCH of the SSB Type-1 which is detected by the UE and partially indicated by/derived from a DMRS of a PBCH of the SSB Type-1 which is detected by the UE, or the frequency offset can be signaled in a system information block (e.g., SIB1). In an example of this option, the frequency offset can be an integer multiple of a predefined frequency granularity, wherein the integer multiple is predefined per frequency band per subcarrier spacing.

Although FIG. 9 illustrates one example synchronization raster design 900, various changes may be made to FIG. 9. For example, various changes to the number of synchronization rasters could be made, various changes to the frequency granularity of the synchronization rasters could be made, etc. according to particular needs.

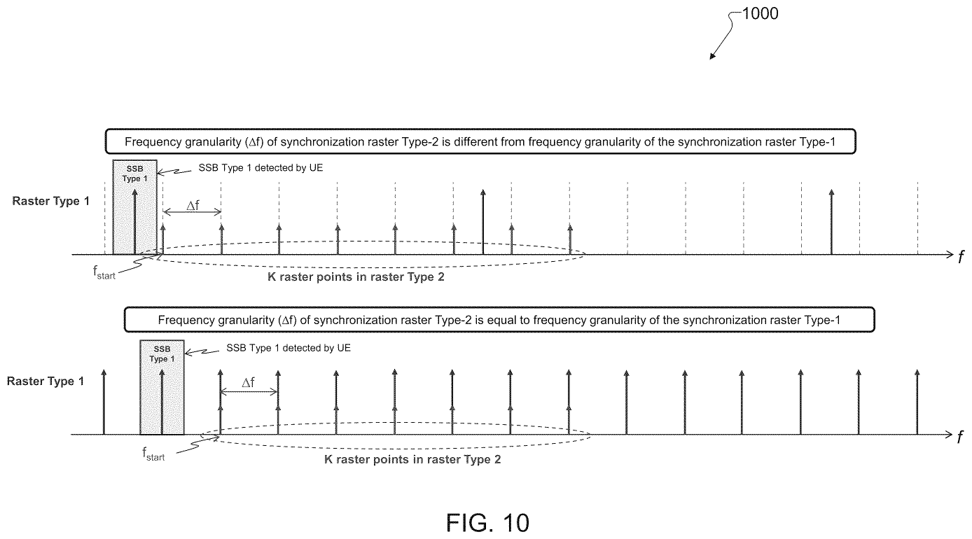

In some embodiments, a value of fₛₜₐᵣₜ can be determined by a predefined rule, similar as shown in FIGS. 10-14. In embodiments such as these, the predefined rule can be specified in the specifications of a technical standard.

FIG. 10 illustrates an example synchronization raster design 1000, where a value of fₛₜₐᵣₜ is determined by a predefined rule according to embodiments of the present disclosure. The embodiment of a synchronization raster design of FIG. 10 is for illustration only. Different embodiments of a synchronization raster design could be used without departing from the scope of this disclosure.

In the example of FIG. 10, the K raster points of a synchronization raster Type-j, where 2≤j≤M, are centered at a raster point in synchronization raster Type-1 on which a UE detects an SSB Type-1.

Although FIG. 10 illustrates one example synchronization raster design 1000, various changes may be made to FIG. 10. For example, various changes to the number of synchronization rasters could be made, various changes to the frequency granularity of the synchronization rasters could be made, etc. according to particular needs.

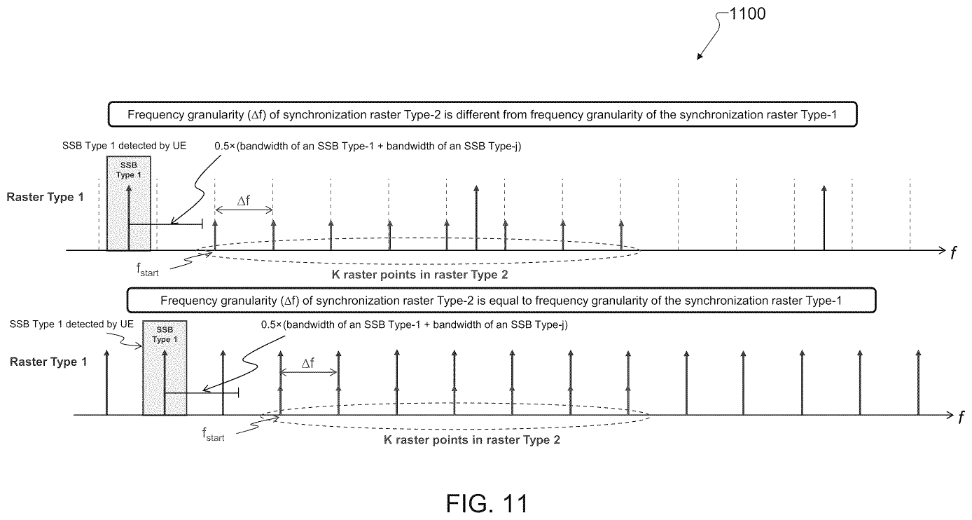

FIG. 11 illustrates another example synchronization raster design 1100, where a value of fₛₜₐᵣₜ is determined by a predefined rule according to embodiments of the present disclosure. The embodiment of a synchronization raster design of FIG. 11 is for illustration only. Different embodiments of a synchronization raster design could be used without departing from the scope of this disclosure.

In the example of FIG. 11, the K raster points of a synchronization raster Type-j, where 2≤j≤M, are a subset of K consecutive frequency points based on a frequency grid of granularity Δf, wherein fₛₜₐᵣₜ is a lowest frequency point in the frequency grid which is larger than a raster point in synchronization raster Type-1 on which a UE detects an SSB Type-1.

Although FIG. 11 illustrates one example synchronization raster design 1100, various changes may be made to FIG. 11. For example, various changes to the number of synchronization rasters could be made, various changes to the frequency granularity of the synchronization rasters could be made, etc. according to particular needs.

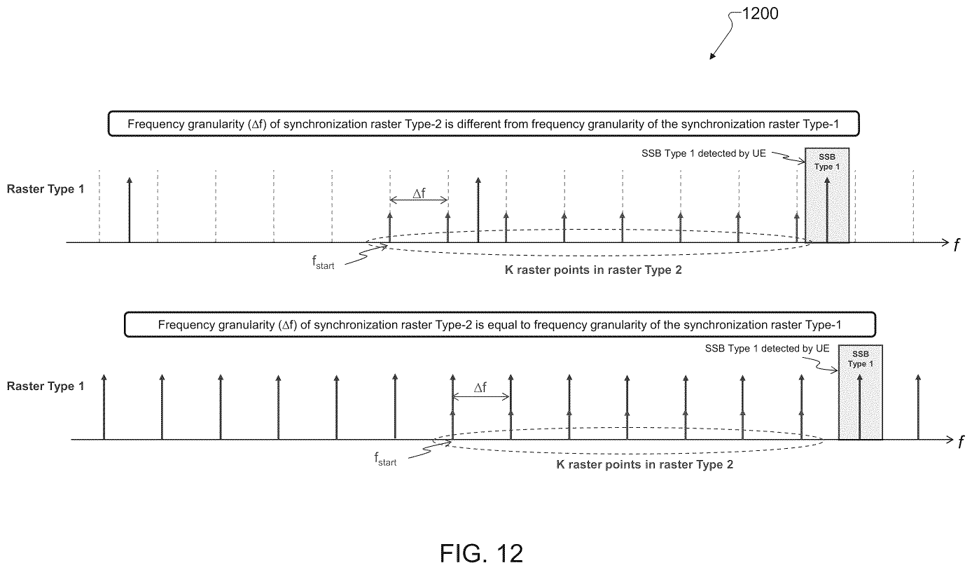

FIG. 12 illustrates another example synchronization raster design 1200, where a value of fₛₜₐᵣₜ is determined by a predefined rule according to embodiments of the present disclosure. The embodiment of a synchronization raster design of FIG. 12 is for illustration only. Different embodiments of a synchronization raster design could be used without departing from the scope of this disclosure.

In the example of FIG. 12, the K raster points of a synchronization raster Type-j, where 2≤j≤M, are a subset of K consecutive frequency points based on a frequency grid of granularity Δf, wherein fₛₜₐᵣₜ is a lowest frequency point in the frequency grid which is larger than a raster point in synchronization raster Type-1 on which a UE detects an SSB Type-1 by at least an offset. The offset is equal to 0.5×(bandwidth of an SSB Type-1+bandwidth of an SSB Type-j).

Although FIG. 12 illustrates one example synchronization raster design 1100, various changes may be made to FIG. 12. For example, various changes to the number of synchronization rasters could be made, various changes to the frequency granularity of the synchronization rasters could be made, etc. according to particular needs.

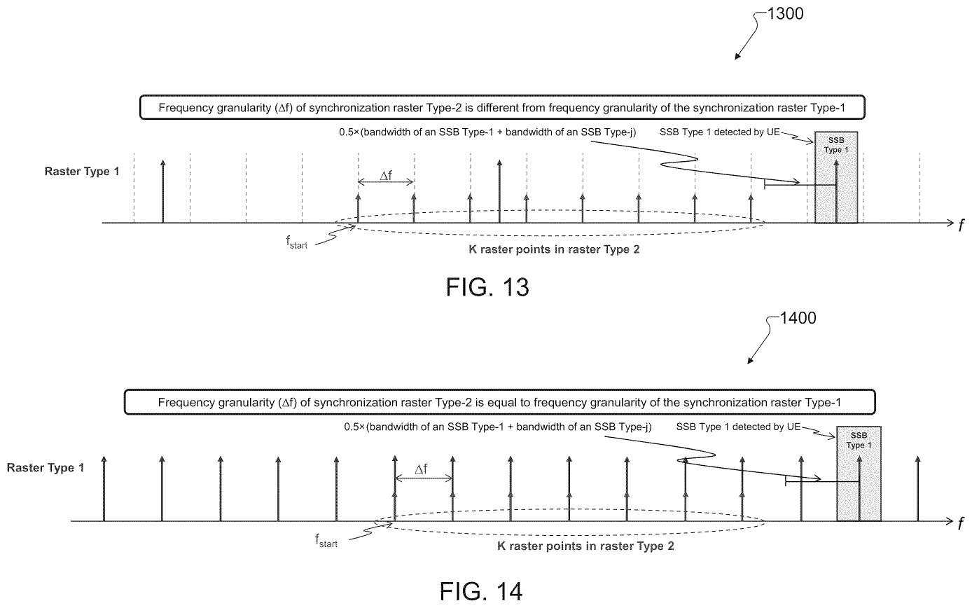

FIG. 13 illustrates another example synchronization raster design 1300, where a value of fₛₜₐᵣₜ is determined by a predefined rule according to embodiments of the present disclosure. The embodiment of a synchronization raster design of FIG. 13 is for illustration only. Different embodiments of a synchronization raster design could be used without departing from the scope of this disclosure.

In the example of FIG. 13, the K raster points of a synchronization raster Type-j, where 2≤j<M, are a subset of K consecutive frequency points based on a frequency grid of granularity Δf, wherein fₛₜₐᵣₜ+(K−1)Δf is a highest frequency point in the frequency grid which is smaller than a raster point in synchronization raster Type-1 on which a UE detects an SSB Type-1.

Although FIG. 13 illustrates one example synchronization raster design 1300, various changes may be made to FIG. 13. For example, various changes to the number of synchronization rasters could be made, various changes to the frequency granularity of the synchronization rasters could be made, etc. according to particular needs.

FIG. 14 illustrates another example synchronization raster design 1400, where a value of fₛₜₐᵣₜ is determined by a predefined rule according to embodiments of the present disclosure. The embodiment of a synchronization raster design of FIG. 14 is for illustration only. Different embodiments of a synchronization raster design could be used without departing from the scope of this disclosure.

In the example of FIG. 14, the K raster points of a synchronization raster Type-j, where 2≤j≤M, are a subset of K consecutive frequency points based on a frequency grid of granularity Δf, wherein fₛₜₐᵣₜ+(K−1)Δf is a highest frequency point in the frequency grid which is smaller a raster point in synchronization raster Type-1 on which a UE detects an SSB Type-1 by at least an offset. The offset is equal to 0.5×(bandwidth of an SSB Type-1+bandwidth of an SSB Type-j).

Although FIG. 14 illustrates one example synchronization raster design 1400, various changes may be made to FIG. 14. For example, various changes to the number of synchronization rasters could be made, various changes to the frequency granularity of the synchronization rasters could be made, etc. according to particular needs.

In some embodiments, a value of K and/or Δf can be determined by any of the alternatives 1 and 2 described below. In an example, for any of these alternatives 1 and 2, a synchronization raster Type-1 and a synchronization raster Type-j, where 2≤j≤M, can be different subsets with different frequency granularities of a same mother frequency grid. In another example, for any of these alternatives 1 and 2, a synchronization raster Type-j, where 2≤j≤M, can be a subset of a synchronization raster Type-1.

Alternative 1: A value of K and/or Δf are predefined and are specified in specifications of a technical standard. The value of frequency granularity (Δf) of synchronization raster Type-j, where 2≤j<M, may be different from a value of frequency granularity of the synchronization raster Type-1. Alternatively, a value of frequency granularity (Δf) of synchronization raster Type-j, where 2≤j≤M, may be equal to a value of frequency granularity of the synchronization raster Type-1.

Alternative 1: A value of K and/or Δf is signaled in a payload of a PBCH of an SSB Type-1 which is detected by the UE, or indicated by/derived from a DMRS of a PBCH of an SSB Type-1 which is detected by the UE, or partially signaled in a payload of a PBCH of an SSB Type-1 which is detected by the UE and partially indicated by/derived from a DMRS of a PBCH of the SSB Type-1 which is detected by the UE, or can be signaled in a system information block (e.g., SIB1).

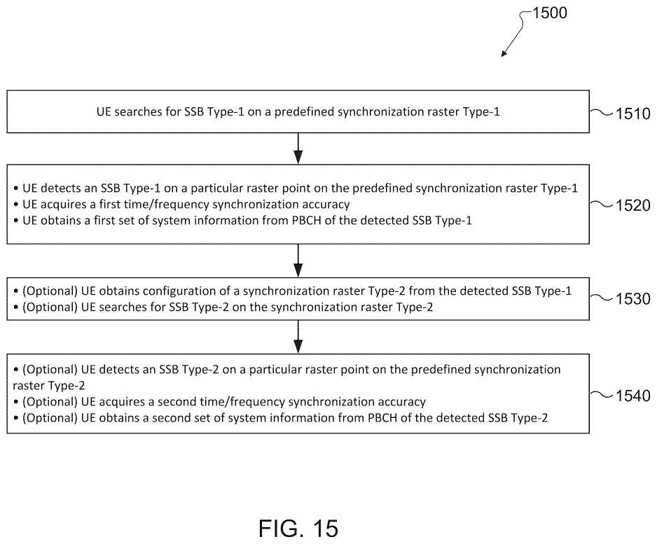

FIG. 15 illustrates another example UE procedure for SSB detection 1500 according to embodiments of the present disclosure. An embodiment of the procedure illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a procedure for SSB detection could be used without departing from the scope of this disclosure.

In the example of FIG. 15, the procedure 1500 begins at operation 1510. At operation 1510, a UE (such as UE 116 of FIG. 1) searches for SSB Type-1 on a predefined synchronization raster Type-1. For example, the predefined synchronization raster Type-1 could be similar as described regarding any of FIGS. 7A-7D and 9-14.

At operation 1520, the UE detects an SSB Type-1 on a particular raster point on the predefined synchronization raster Type-1, acquires a first time/frequency synchronization accuracy, and obtains a first set of system information from PBCH of the detected SSB Type-1.

Optionally, at operation 1530, the UE obtains configuration of a synchronization raster Type-2 from the detected SSB Type-1, and searches for SSB Type-2 on the synchronization raster Type-2. For example, the raster Type-2 could be similar as described regarding any of FIGS. 7A-7D and 9-14.

Optionally, at operation 1540, the UE detects an SSB Type-2 on a particular raster point on the predefined synchronization raster Type-2, acquires a second time/frequency synchronization accuracy, and obtains a second set of system information from PBCH of the detected SSB Type-2.

Although FIG. 15 illustrates one example UE procedure for SSB detection 1500, various changes may be made to FIG. 15. For example, while shown as a series of operations, various operations in FIG. 15 could overlap, occur in parallel, occur in a different order, occur any number of times, be omitted, or replaced by other operations.

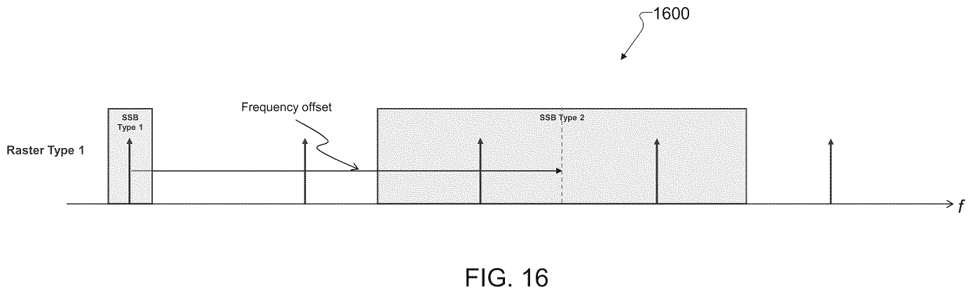

In some embodiments, such as shown in FIGS. 16-19, a number “M” of SSB types (i.e., SSB Type-1, SSB Type-2, . . . , SSB Type-M) can be specified in the specifications of a technical standard. In embodiments such as these, a first synchronization raster (i.e., synchronization raster Type-1, for SSB Type-1) can also be specified in the specifications of the same technical standard. For an SSB Type-j, where 2≤j≤M, a frequency location of the SSB can be determined by a UE after detecting the SSB Type-1 on the synchronization raster Type-1, using a frequency offset between a reference frequency point of the SSB Type-1 and a reference frequency point of the SSB Type-j. Optionally, in some embodiments, a UE can determine a time location of an SSB Type-j, where 2≤j≤M, after detecting the SSB Type-1, using a time offset between a reference time point of the SSB Type-1 and a reference time point of the SSB Type-j.

A reference frequency point of an SSB Type-j can be a middle subcarrier of the SSB Type-j. If an SSB Type-j has N subcarriers indexed from 0 to N-1, where Nis an even number, the middle subcarrier of the SSB Type-j is defined as subcarrier with index N/2. Alternatively, a reference frequency point of an SSB Type-j can be a raster point of a corresponding synchronization raster Type-j on which the SSB Type-j is transmitted. Optionally, a reference time point of an SSB Type-j can be a beginning of a first OFDM symbol over which the SSB Type-j is transmitted.

In some embodiments, a value of the frequency offset can be predefined and specified in specifications of a technical standard.

In some embodiments, a value of the frequency offset can be signaled in a payload of a PBCH of the SSB Type-1 which is detected by the UE, or indicated by/derived from a DMRS of a PBCH of the SSB Type-1 which is detected by the UE, or partially signaled in a payload of a PBCH of the SSB Type-1 which is detected by the UE and partially indicated by/derived from a DMRS of a PBCH of the SSB Type-1 which is detected by the UE, or can be signaled in a system information block (e.g., SIB1).

FIG. 16 illustrates an example synchronization raster design 1600, where a frequency location of SSB Type-2 is determined from an SSB Type-1 which is detected by a UE on synchronization raster Type-1 according to embodiments of the present disclosure. The embodiment of a synchronization raster design of FIG. 16 is for illustration only. Different embodiments of a synchronization raster design could be used without departing from the scope of this disclosure.

In the example of FIG. 16, SSB Type-2 is not located on a particular synchronization raster.

Although FIG. 16 illustrates one example synchronization raster design 1600, various changes may be made to FIG. 16. For example, various changes to the number of synchronization rasters could be made, various changes to the frequency granularity of the synchronization rasters could be made, etc. according to particular needs.

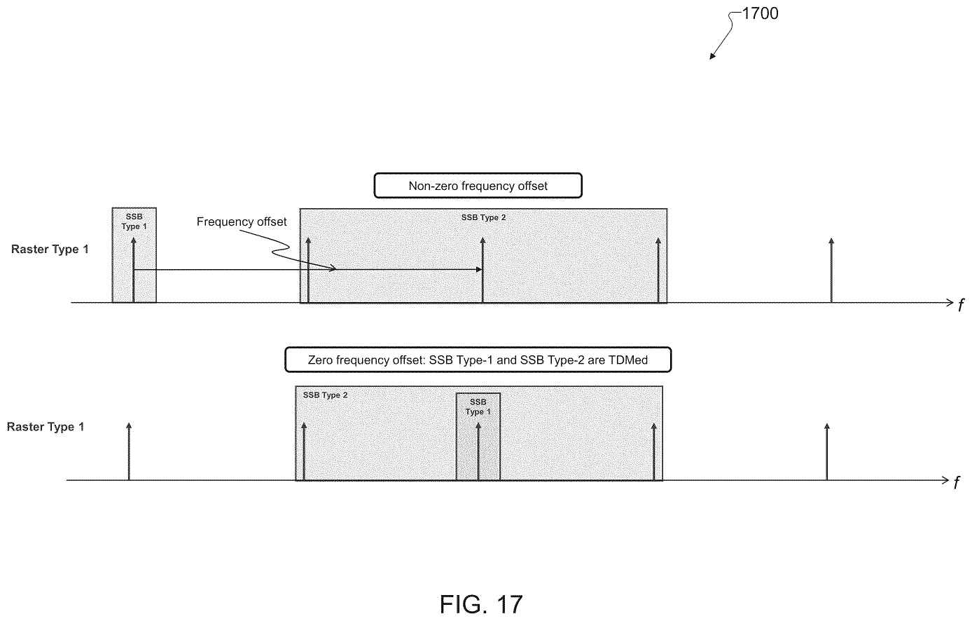

FIG. 17 illustrates another example synchronization raster design 1700, where a frequency location of SSB Type-2 is determined from an SSB Type-1 which is detected by a UE on synchronization raster Type-1 according to embodiments of the present disclosure. The embodiment of a synchronization raster design of FIG. 17 is for illustration only. Different embodiments of a synchronization raster design could be used without departing from the scope of this disclosure.

In the example of FIG. 17, SSB Type-2 is located on a same synchronization raster as SSB Type-1.

Although FIG. 17 illustrates one example synchronization raster design 1700, various changes may be made to FIG. 17. For example, various changes to the number of synchronization rasters could be made, various changes to the frequency granularity of the synchronization rasters could be made, etc. according to particular needs.

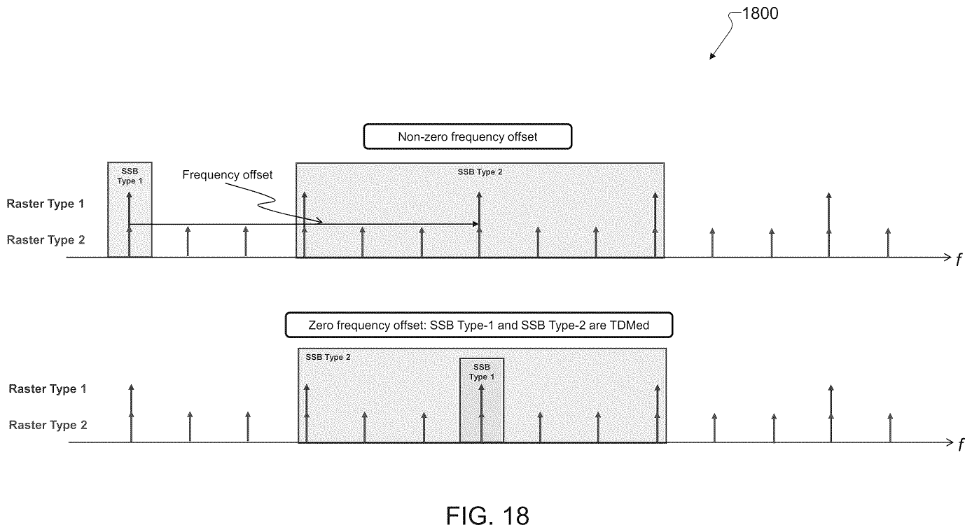

FIG. 18 illustrates another example synchronization raster design 1800, where a frequency location of SSB Type-2 is determined from an SSB Type-1 which is detected by a UE on synchronization raster Type-1 according to embodiments of the present disclosure. The embodiment of a synchronization raster design of FIG. 18 is for illustration only. Different embodiments of a synchronization raster design could be used without departing from the scope of this disclosure.

In the example of FIG. 18, SSB Type-2 is located on a synchronization raster Type-2 which is different from synchronization raster Type-1 of SSB Type-1.

Although FIG. 18 illustrates one example synchronization raster design 1800, various changes may be made to FIG. 18. For example, various changes to the number of synchronization rasters could be made, various changes to the frequency granularity of the synchronization rasters could be made, etc. according to particular needs.

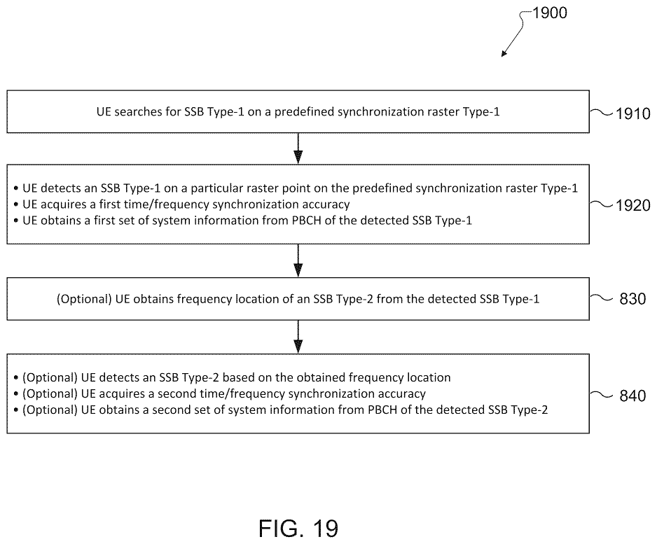

FIG. 19 illustrates an example UE procedure for SSB detection 1900 according to embodiments of the present disclosure. An embodiment of the procedure illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of a procedure for SSB detection could be used without departing from the scope of this disclosure.

In the example of FIG. 19, the procedure 1900 begins at operation 1910. At operation 1910, a UE (such as UE 116 of FIG. 1) searches for SSB Type-1 on a predefined synchronization raster Type-1. For example, the predefined synchronization raster Type-1 could be similar as described regarding any of FIGS. 16-18.

At operation 1920, the UE detects an SSB Type-1 on a particular raster point on the predefined synchronization raster Type-1, acquires a first time/frequency synchronization accuracy, and obtains a first set of system information from PBCH of the detected SSB Type-1.

Optionally, at operation 1930, the UE obtains frequency location of an SSB Type-2 from the detected SSB Type-1. For example, the predefined synchronization raster Type-2 could be similar as described regarding any of FIGS. 16-18.

Optionally, at operation 1940, the UE detects an SSB Type-2 based on the obtained frequency location, acquires a second time/frequency synchronization accuracy, and obtains a second set of system information from PBCH of the detected SSB Type-2.

Although FIG. 19 illustrates one example UE procedure for SSB detection 1900, various changes may be made to FIG. 19. For example, while shown as a series of operations, various operations in FIG. 19 could overlap, occur in parallel, occur in a different order, occur any number of times, be omitted, or replaced by other operations.

In some embodiments, more than one SSB of a same type can be transmitted in an FDMed manner (i.e., they are transmitted over a same time duration and different non-overlapping frequency subbands). In embodiments such as these, each SSB can be transmitted on a raster point of a same synchronization raster. The synchronization raster can be comprised of a set of raster clusters, each including K raster points with a first frequency granularity (Δf₁), wherein the raster clusters are spaced apart in frequency with a second frequency granularity (Δf₂), and wherein for example Δf₁ is smaller than Δf₂. In some embodiments, the values of K, and/or Δf₁, and/or Δf₂ can be predefined and specified in the specification of a technical standard. Alternatively, in some embodiments, the values of K, and/or Δf₁, and/or Δf₂ can be signaled in one or a combination of a DMRS of PBCH, and/or a payload of a PBCH, and/or a system information block (e.g., SIB1), and/or dedicated RRC parameters (e.g., a serving cell configuration).

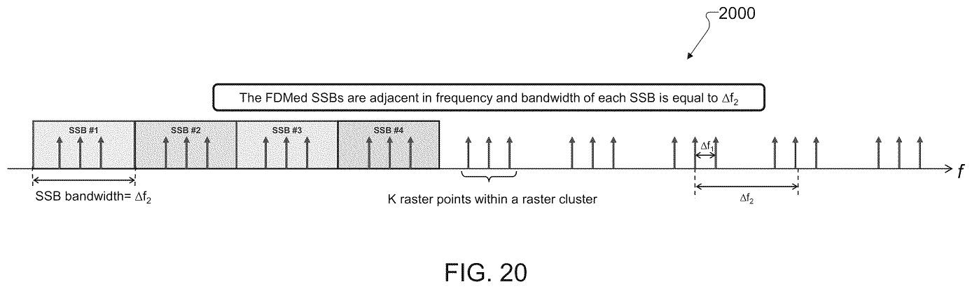

In some embodiments, the FDMed SSBs can be adjacent in frequency and the bandwidth of each SSB can be equal to Δf₂, similar as shown in FIG. 20.

FIG. 20 illustrates a synchronization raster design 2000, where FDMed SSBs are adjacent in frequency and the bandwidth of each SSB is equal to Δf₂. according to embodiments of the present disclosure. The embodiment of a synchronization raster design of FIG. 20 is for illustration only. Different embodiments of a synchronization raster design could be used without departing from the scope of this disclosure. Although FIG. 20 illustrates one example synchronization raster design 2000, various changes may be made to FIG. 20. For example, various changes to the number of synchronization rasters could be made, various changes to the frequency granularity of the synchronization rasters could be made, etc. according to particular needs.

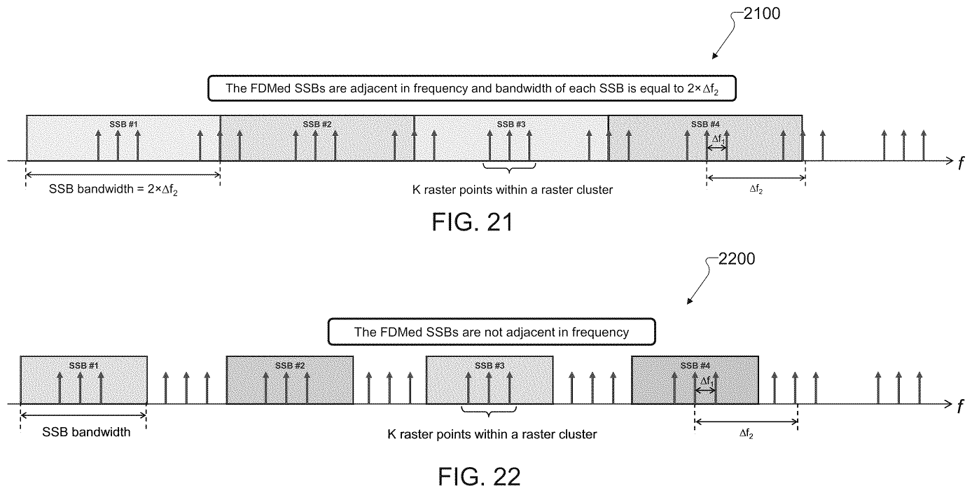

In some embodiments, the FDMed SSBs can be adjacent in frequency and the bandwidth of each SSB can be an integer multiple of Δf₂, similar as shown in FIG. 21.

FIG. 21 illustrates a synchronization raster design 2100, where FDMed SSBs are adjacent in frequency and the bandwidth of each SSB is equal to 2×Δf₂ according to embodiments of the present disclosure. The embodiment of a synchronization raster design of FIG. 21 is for illustration only. Different embodiments of a synchronization raster design could be used without departing from the scope of this disclosure. Although FIG. 21 illustrates one example synchronization raster design 2100, various changes may be made to FIG. 21. For example, various changes to the number of synchronization rasters could be made, various changes to the frequency granularity of the synchronization rasters could be made, etc. according to particular needs.

In some embodiments, the FDMed SSBs may not be adjacent in frequency, (i.e. there may be a frequency guard between each pair of neighboring SSBs in frequency), similar as shown in FIG. 22.

FIG. 22 illustrates a synchronization raster design 2200, where FDMed SSBs are not adjacent in frequency according to embodiments of the present disclosure. The embodiment of a synchronization raster design of FIG. 22 is for illustration only. Different embodiments of a synchronization raster design could be used without departing from the scope of this disclosure. Although FIG. 22 illustrates one example synchronization raster design 2200, various changes may be made to FIG. 22. For example, various changes to the number of synchronization rasters could be made, various changes to the frequency granularity of the synchronization rasters could be made, etc. according to particular needs.

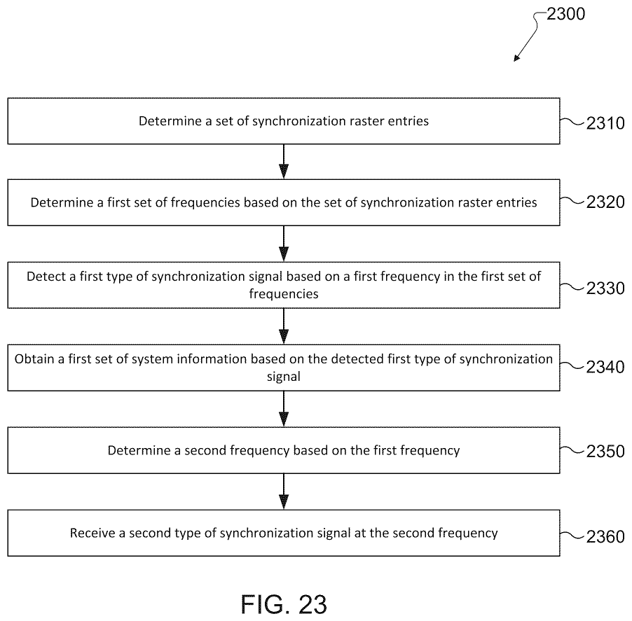

FIG. 23 illustrates an example method for SSB detection 2300 according to embodiments of the present disclosure. An embodiment of the method illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of a method for SSB detection could be used without departing from the scope of this disclosure.

In the example of FIG. 23, the method 2300 begins at step 2310. At step 2310, a UE (such as UE 116 of FIG. 1) determines a set of synchronization raster entities (e.g., a number “M” of synchronization rasters [i.e., synchronization raster Type-1, synchronization raster Type-2, . . . , synchronization raster Type-M]). In some embodiments, the set of synchronization raster entries may be pre-determined for the wireless communication system. For example, the set of synchronization raster entries may be specified in specifications of a technical standard for the wireless communication system.

At step 2320, the UE determines a first set of frequencies based on the set of synchronization raster entries.

At step 2330, the UE detects a first type of synchronization signal (e.g., an SSB Type-1) based on a first frequency in the first set of frequencies. In some embodiments, the first frequency may correspond to a center subcarrier of the first type of synchronization signal.

At step 2340, the UE obtains a first set of system information based on the detected first type of synchronization signal.

At step 2350, the UE determines a second frequency based on the first frequency. For example, in some embodiments, the UE may apply a frequency offset to the first frequency to obtain the second frequency, similarly as described regarding FIGS. 6-7D and 9.

In some embodiments, the frequency offset may be a pre-determined offset specified for the wireless communication system. For example, the frequency offset may be specified in specifications of a technical standard for the wireless communication system.

In some embodiments, the UE may determine the frequency offset based on information indicated in a payload of a PBCH comprised in the first type of synchronization signal, and applying the frequency offset to the first frequency to obtain the second frequency.

In some embodiments, the second frequency may correspond to a center subcarrier of the second type of synchronization signal.

At step 2360, the UE receives a second type of synchronization signal (e.g., an SSB Type-2) at the second frequency.

Although FIG. 23 illustrates one example method for SSB detection 2300, various changes may be made to FIG. 23. For example, while shown as a series of steps, various steps in FIG. 23 could overlap, occur in parallel, occur in a different order, occur any number of times, be omitted, or replaced by other steps.

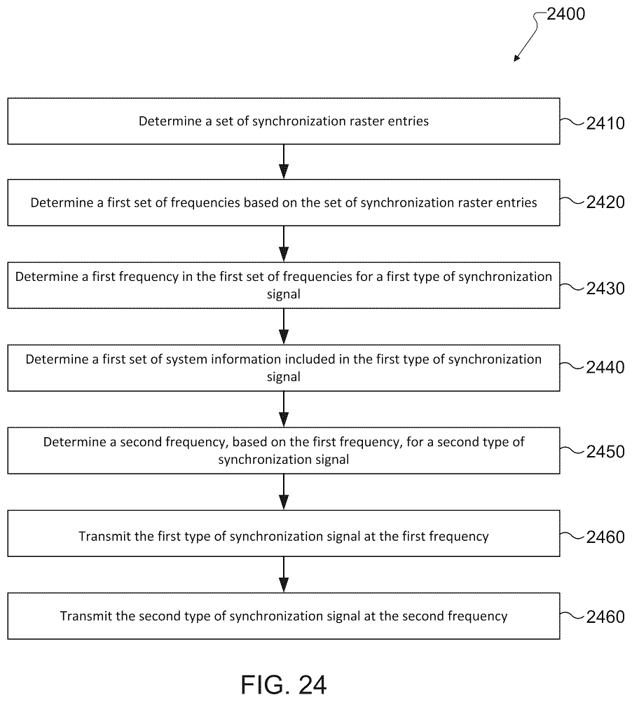

FIG. 24 illustrates an example method for SSB detection 2400 according to embodiments of the present disclosure. An embodiment of the method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of a method for SSB detection could be used without departing from the scope of this disclosure.

In the example of FIG. 24, the method 2400 begins at step 2410. At step 2410, a BS (such as BS 102 of FIG. 1) determines a set of synchronization raster entities (e.g., a number “M” of synchronization rasters [i.e., synchronization raster Type-1, synchronization raster Type-2, . . . , synchronization raster Type-M]). In some embodiments, the set of synchronization raster entries may be pre-determined for the wireless communication system. For example, the set of synchronization raster entries may be specified in specifications of a technical standard for the wireless communication system.

At step 2420, the BS determines a first set of frequencies based on the set of synchronization raster entries.

At step 2430, the BS determines a first frequency in the first set of frequencies for a first type of synchronization signal (e.g., an SSB Type-1). In some embodiments, the first frequency may correspond to a center subcarrier of the first type of synchronization signal.

At step 2440, the BS determines a first set of system information included in the first type of synchronization signal.

At step 2450, the BS determines a second frequency, based on the first frequency, for a second type of synchronization signal (e.g., an SSB Type-2). For example, in some embodiments, the UE may apply a frequency offset to the first frequency to obtain the second frequency, similarly as described regarding FIGS. 6-7D and 9.

In some embodiments, the frequency offset may be a pre-determined offset specified for the wireless communication system. For example, the frequency offset may be specified in specifications of a technical standard for the wireless communication system.

In some embodiments, the UE may determine the frequency offset based on information indicated in a payload of a PBCH comprised in the first type of synchronization signal, and applying the frequency offset to the first frequency to obtain the second frequency.

In some embodiments, the second frequency may correspond to a center subcarrier of the second type of synchronization signal.

At step 2460, the BS transmits the first type of synchronization signal at the first frequency.

At step 2470, the BS transmits the second type of synchronization signal at the second frequency.

Although FIG. 24 illustrates one example method for SSB detection 2400, various changes may be made to FIG. 24. For example, while shown as a series of steps, various steps in FIG. 24 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE) in a wireless communication system, the method comprising:
determining a set of synchronization raster entries;
determining a first set of frequencies based on the set of synchronization raster entries;
detecting a first type of synchronization signal based on a first frequency in the first set of frequencies;
obtaining a first set of system information based on the detected first type of synchronization signal;
determining a second frequency based on the first frequency; and
receiving a second type of synchronization signal at the second frequency.

2. The method of claim 1, further comprising applying a frequency offset to the first frequency to obtain the second frequency.

3. The method of claim 2, wherein the frequency offset is a pre-determined offset specified for the wireless communication system.

4. The method of claim 2, further comprising:
determining the frequency offset based on information indicated in a payload of a physical broadcast channel (PBCH) comprised in the first type of synchronization signal; and
applying the frequency offset to the first frequency to obtain the second frequency.

5. The method of claim 1, wherein the set of synchronization raster entries is pre-determined for the wireless communication system.

6. The method of claim 1, wherein the first frequency corresponds to a center subcarrier of the first type of synchronization signal.

7. The method of claim 1, wherein the second frequency corresponds to a center subcarrier of the second type of synchronization signal.

8. A method of a base station (BS) in a wireless communication system, the method comprising:
determining a set of synchronization raster entries;
determining a first set of frequencies based on the set of synchronization raster entries;
determining a first frequency in the first set of frequencies for a first type of synchronization signal;
determining a first set of system information included in the first type of synchronization signal;
determining a second frequency, based on the first frequency, for a second type of synchronization signal;
transmitting the first type of synchronization signal at the first frequency; and
transmitting the second type of synchronization signal at the second frequency.

9. The method of claim 8, further comprising applying a frequency offset to the first frequency to determine the second frequency.

10. The method of claim 9, wherein the frequency offset is a pre-determined offset specified for the wireless communication system.

11. The method of claim 9, further comprising:
determining the frequency offset based on information indicated in a payload of a physical broadcast channel (PBCH) comprised in the first type of synchronization signal; and
applying the frequency offset to the first frequency to determine the second frequency.

12. The method of claim 8, wherein the set of synchronization raster entries is pre-determined for the wireless communication system.

13. The method of claim 8, wherein the first frequency corresponds to a center subcarrier of the first type of synchronization signal; and the second frequency corresponds to a center subcarrier of the second type of synchronization signal.

14. An electronic device comprising:
at least one processor including processing circuitry; and
memory storing instructions, wherein the instructions, when executed by the at least one processor individually or collectively, cause the electronic device to:
determine a set of synchronization raster entries;
determine a first set of frequencies based on the set of synchronization raster entries;
detect a first type of synchronization signal based on a first frequency in the first set of frequencies;
obtain a first set of system information based on the detected first type of synchronization signal;
determine a second frequency based on the first frequency; and
receive a second type of synchronization signal at the second frequency.

15. The electronic device of claim 14, wherein to determine the second frequency based on the first frequency, the processor is further configured to apply a frequency offset to the first frequency to obtain the second frequency.

16. The electronic device of claim 15, wherein the frequency offset is a pre-determined offset specified for a wireless communication system.

17. The electronic device of claim 15, wherein the first type of synchronization signal comprises a physical broadcast channel (PBCH), and wherein to determine the second frequency based on the first frequency, the processor is further configured to:
determine the frequency offset based on information indicated in a payload of the PBCH of the first type of synchronization signal; and
apply the frequency offset to the first frequency to obtain the second frequency.

18. The electronic device of claim 14, wherein the set of synchronization raster entries is pre-determined for a wireless communication system.

19. The electronic device of claim 14, wherein the first frequency corresponds to a center subcarrier of the first type of synchronization signal.

20. The electronic device of claim 14, wherein the second frequency corresponds to a center subcarrier of the second type of synchronization signal.
